(19) United States
(12) Patent Application Publication
(10) Pub. No.: US 2026/0356639 A1
(43) Pub. Date: Nov. 12, 2026

(54) STABILIZER PAD WITH A CONTINUOUS HANDLE

(71) Applicant: RAPTOR TECH, INC., Downers Grove, IL (US)

(72) Inventors: Paul S. PERKINS, II, Downers Grove, IL (US); Timothy SMITH, Downers Grove, IL (US)

(21) Appl. No.: 19/283,267

(22) Filed: Jul. 29, 2025

Related U.S. Application Data
(60) Provisional application No. 63/677,010, filed on Jul. 30, 2024.

(51) Int. Cl. B66C 23/78

(52) U.S. Cl. CPC B66C 23/78

(57) ABSTRACT

A stabilizer pad that stabilizes equipment—e.g., cranes or vehicles with outriggers—during use as well as protects the ground surface on which the equipment is placed. The stabilizer pad includes a continuous handle around the perimeter of the pad so that a user may grasp the handle component at any point along the perimeter edge of the pad component. The invention eases lifting tasks associated with transporting and positioning stabilizer pads and may reduce the incidence of user injuries. According to the invention, any size pad, even large sizes with a large weight, can be easily maneuvered.

### CROSS-REFERENCE TO RELATED APPLICATIONS

This application claims the benefit of U.S. Provisional Patent Application 63/677,010 filed Jul. 30, 2024, incorporated by reference.

### FIELD OF THE INVENTION

The invention relates generally to field of construction and more particularly, the invention relates to a stabilizer pad that stabilizes equipment—e.g., heavy construction equipment such as cranes or any equipment with an outrigger—during use as well as protects the ground surface on which the equipment is placed.

### BACKGROUND OF THE INVENTION

Stabilizer pads are used with equipment such as cranes or equipment with outriggers. Some stabilizer pads are also known as crane mats, crane pads, outrigger pads, outrigger mats, ground bearing mat, ground bearing pad. A stabilizer pad is used to stabilize the equipment and protect the ground surface on which the equipment is placed. The pad stabilizes the equipment during use to prevent the equipment from moving, e.g., sinking through the ground surface, toppling over, etc. The pad prevents the equipment from breaking through the ground surface—brick, rock, concrete, asphalt, sand, soil, or any other material—and damaging the equipment.

Stabilizer pads provide a solid, even surface creating a sturdy base during equipment operation. Stabilizer pads additionally distribute concentrated loads or disperse weight from the outrigger. Stabilizer pads can be extremely heavy in weight (e.g., over 50 pounds) and are known to be transported by rolling along its edge. Heavy pads may be difficult to transport in this fashion and come with a risk of becoming unsteady and toppling over.

A stabilizer pad can also be transported by being manually pulled or lifted by a machine, both which may further require lanyards or straps secured to the pad. Some pads have handles to assist with transporting them. These handles may be constructed of rope that is secured through holes in the mat, but the integrity of rope handles easily deteriorate over repeated use and eventually break apart. Handles constructed of cable are known to be attached using pins through anchor holes, which may become insecure risking detachment from the mat. This may be particularly problematic if detachment of the handle from the pad occurs while lifted and moved by a machine. Furthermore, certain known cable handles are positioned along the perimeter edge of the pad but are fixed and offer a small or low clearance (e.g., 0-¾ inches) with the ground surface making it difficult for a user to position his or her hand around the handle. Moreover, pads may only include one handle and if two handles are provided, they are spaced apart and may not be located where the user needs a handle to be when trying to lift or move the pad.

What is needed is an improved stabilizer pad, i.e., one that is easy to transport, includes ergonomic features, and includes a handle that is easily accessible and available to a user at any point around the pad. The invention satisfies this need.

### BRIEF SUMMARY OF THE INVENTION

Although the invention is described with respect to a crane, any vehicle with an outrigger or other support structure of the equipment is contemplated. The invention is directed to a stabilizer pad that stabilizes equipment—e.g., cranes or vehicles with outriggers—during use as well as protects the ground surface on which the equipment is placed.

The stabilizer pad includes an ergonomic handle that is a continuous component around the outer perimeter of the pad and further may be moveable about the outer perimeter of the pad. The handle may be a flexible component such that it is manipulable to cinch around the pad to form a lanyard element. Advantageously, a user may grasp the handle component at any point along the perimeter edge of the pad component, e.g., for a circle shaped pad the handle is accessible at any point around the 360-degree perimeter of the pad.

The lanyard element may be used to attach a lifting hook of a machine to move the stabilizer pad or the lanyard element may also be used to manually move or drag the stabilizer pad. The invention eases lifting tasks associated with transporting and positioning stabilizer pads and may reduce the incidence of user injuries. According to the invention, any size pad, even large sizes with a large weight, can be easily handled.

The pad component of the stabilizer pad may be manufactured of any contemplated material, such as wood, plywood, metal, steel, rubber, plastic, bamboo, concrete, aluminum, fiberglass, thermoplastics, to name a few. It is contemplated that the handle component may be manufactured from any natural or synthetic materials-hemp, linen, cotton, coir, jute, straw, sisal, polypropylene, nylon, polyesters, polyethylene, etc. For example, the handle component may be a rope or cable.

The invention and its attributes and advantages will be further understood and appreciated with reference to the detailed description below of presently contemplated embodiments, taken in conjunction with the accompanying drawings.

### BRIEF DESCRIPTION OF THE FIGURES

The preferred embodiments of the invention are described in conjunction with the attached figures that illustrate embodiments of the invention.

FIG. 1 illustrates a perspective view of a stabilizer pad with a continuous handle component.

FIG. 2 illustrates a top view of a stabilizer pad with a continuous handle component.

FIG. 3 illustrates a side view of a stabilizer pad with a continuous handle component.

FIG. 4 illustrates a top view of a stabilizer pad with a continuous handle component.

FIG. 5 illustrates a perspective view of another embodiment of a stabilizer pad with a continuous handle component.

FIG. 6 illustrates a top view of a stabilizer pad with a continuous handle component.

FIG. 7 illustrates a top view of a connection arrangement between a stabilizer pad and a continuous handle component.

FIG. 8 illustrates a top view of a connection arrangement between a stabilizer pad and a continuous handle component.

FIG. 9A illustrates an enlarged view of a connection arrangement.

FIG. 9B illustrates an enlarged view of a connection arrangement.

FIG. 9C illustrates an enlarged view of a connection arrangement.

FIG. 9D illustrates an enlarged view of a connection arrangement.

FIG. 9E illustrates an enlarged view of a connection arrangement.

FIG. 9F illustrates an enlarged view of a connection arrangement.

FIG. 10A illustrates a hand grip element of the continuous handle component.

FIG. 10B illustrates a hand grip element of the continuous handle component.

FIG. 10C illustrates a hand grip element of the continuous handle component.

FIG. 10D illustrates a hand grip element of the continuous handle component.

FIG. 11 illustrates a side view of a stabilizer pad with concave side wall surface.

FIG. 12 illustrates an enlarged view of a side wall surface.

FIG. 13 illustrates an enlarged view of a side wall surface.

FIG. 14 illustrates an enlarged view of a side wall surface with texture element.

### DETAILED DESCRIPTION OF THE INVENTION

The invention is directed to a stabilizer pad that stabilizes equipment—e.g., cranes or vehicles with outriggers—during use. For purposes of this application the stabilizer pad is shown and described as a circular shape, but any shape is contemplated, e.g., square, rectangle, octagon, etc. However, a circular shape is known to work well for rolling the pad on its edge. The stabilizer pad comprises a handle component as a continuous, flexible element positioned around the outer perimeter of the pad. The handle component is moveable at a point of contact to tighten or cinch around the pad component and form an extended portion, or lanyard element, for moving or lifting the stabilizer pad. The lanyard element is used to attach a lifting hook of a machine to move the stabilizer pad and may also be used to manually move or drag the stabilizer pad. Advantageously, a user may grasp the handle component at any point along the perimeter edge of the pad component. For a circle shaped pad, the handle is accessible at any point around the 360-degree perimeter of the pad.

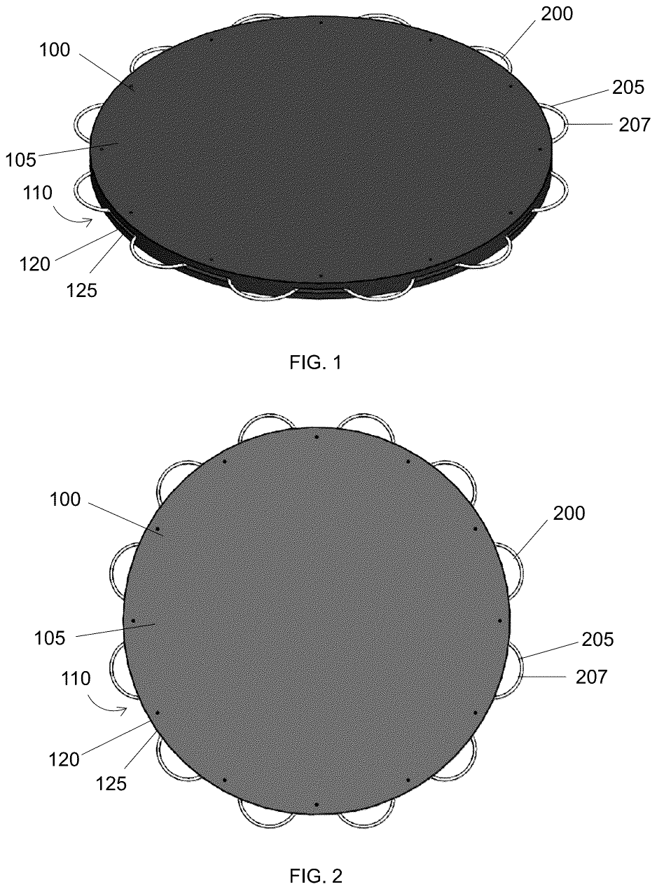

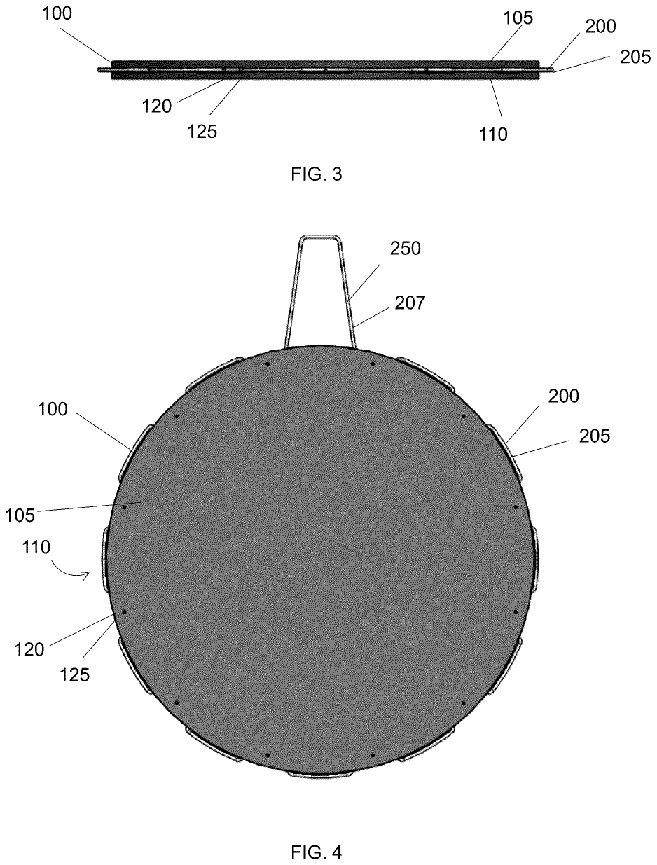

FIG. 1 through FIG. 4 illustrate a stabilizer pad with a continuous handle component. The stabilizer pad includes a pad component 100 including a first surface 105, an opposing second surface 110, and a side wall surface 120 between the first surface 105 and the opposing second surface 110 and forming a perimeter edge 125. The pad includes a handle component 200, wherein the handle component 200 is continuous, flexible element 205 positioned around the perimeter edge 125. The handle component 200 is moveable at a point of contact to tighten or cinch around the pad component 100 and forms a lanyard element 250 for moving or lifting the stabilizer pad.

The continuous handle component 200 is moveable. In a resting state, the handle component 200 is a flexible element 205 that forms a plurality of loops 207. Any of the loops 207 may be grasped to move the handle 200 and pull it into a taut state, i.e., the handle component 200 is cinched. The loop 207 selected forms a lanyard element 250 while the remaining loops 207 are moved into a tight position around the perimeter edge 125, e.g., the handle abuts, or touches, the side wall surface 120.

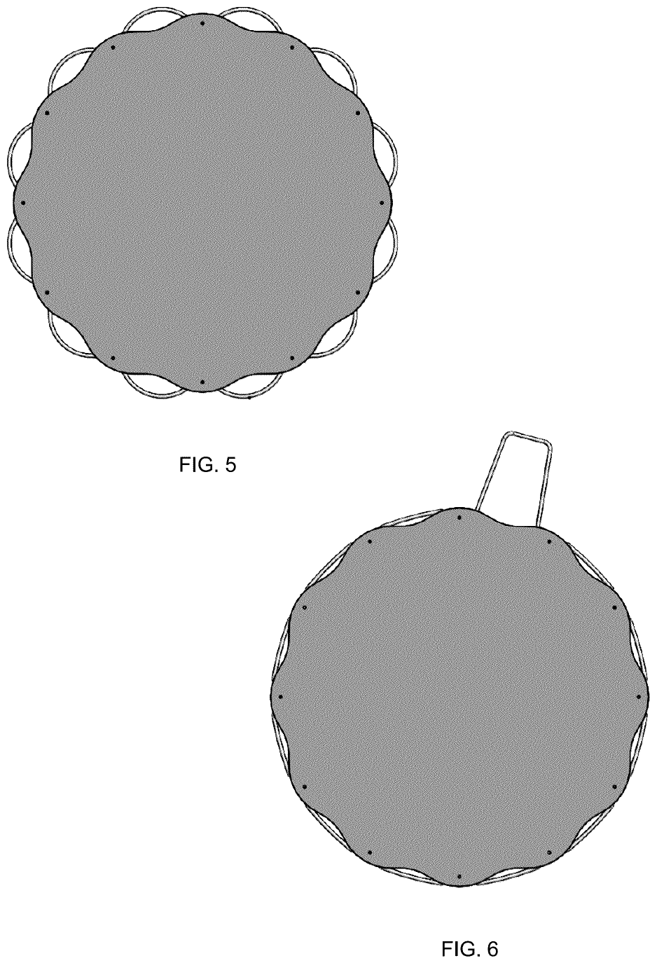

While the pad shown in FIG. 1 through FIG. 4 illustrate a circular shaped pad with a uniform edge, FIG. 5 and FIG. 6 illustrate a pad with scalloped perimeter edge 125.

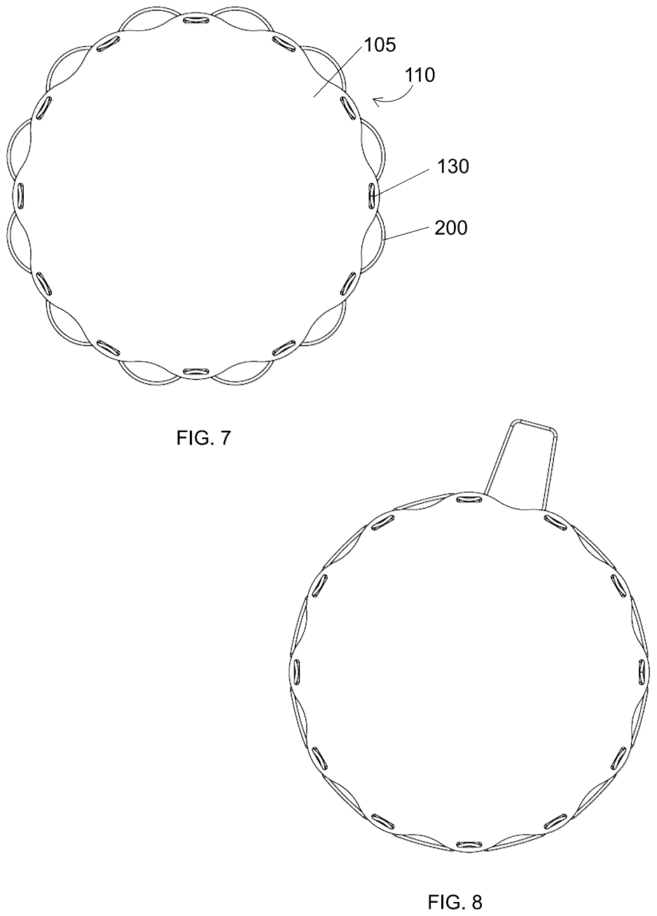

FIG. 7 and FIG. 8 illustrate a connection arrangement 300 between a stabilizer pad 100 and a continuous handle component 200. The top surface 105 or bottom surface 110, or both the top surface 105 and bottom surface 110, include a series of aperture elements 130. The continuous handle component 200 is woven through each aperture element 130.

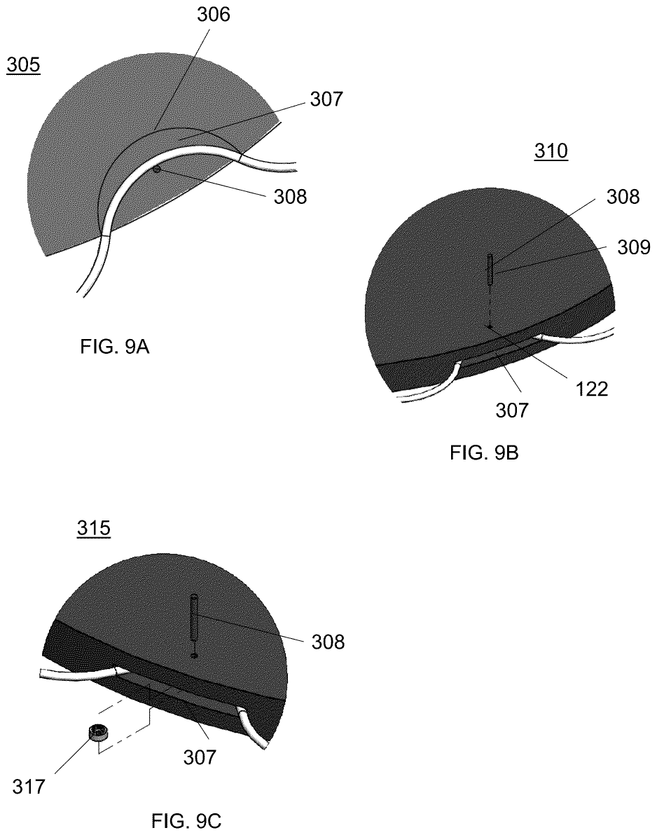

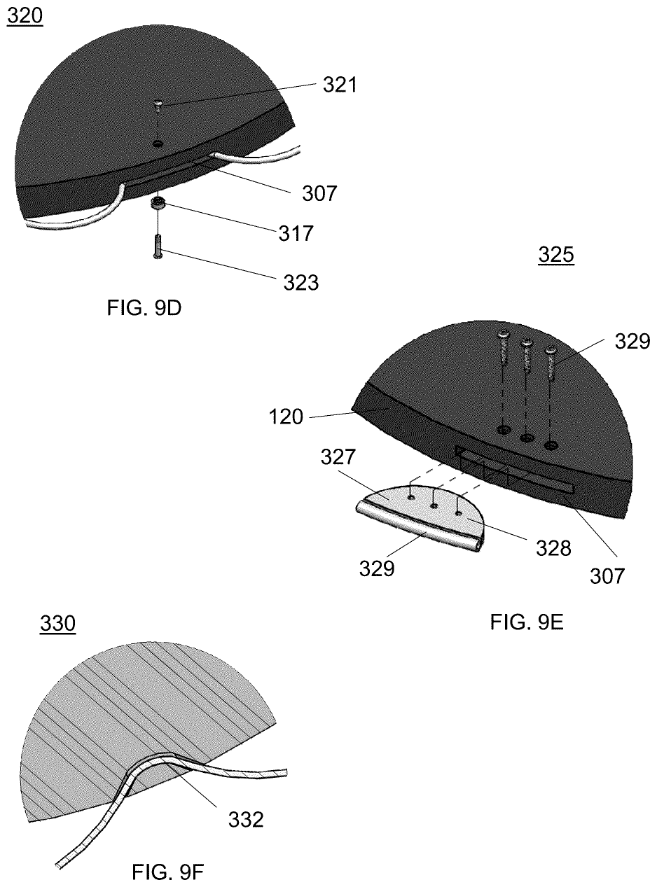

FIG. 9A through FIG. 9F illustrate enlarged views of connection arrangements 300 contemplated by the invention. FIG. 9A illustrates a connection arrangement 305 where the pad component 100 may include a slot or cavity element 307 formed within the pad. The cavity 307 is formed inward from the side wall surface 120 toward a center of the pad and may be machined out of the pad material. The cavity element 307 includes a boundary surface 306 and a pin element 308. The boundary surface 306 and pin element 308 constrain the handle component 200 while permitting it to freely move within the cavity element 307. A pin element 308 is located within the cavity 307 and retains the handle component 200. The pin element 308 may be fixed, or dynamic. A dynamic pin element 308 moves or rotates, such as a roller ball bearing described below, and permits the handle component 200 to freely travel or slide across the pin element 308. The boundary surface 306 is curved to foster a smooth sliding movement of the handle component 200. The handle component 200 does not get stuck or caught by the curved boundary surface 306 when a portion of the handle 200 is grasped and pulled. The pin element 308 constrains the handle component 200 within the cavity element 307 and does not permit it to escape exterior to the perimeter edge 125.

FIG. 9B illustrates a connection arrangement 310 where the pin element 308 is a dowel pin 309 that may be inserted such as press-fit into an opening 122 in the pad component 100. FIG. 9C illustrates a connection arrangement 315 using a roller bearing 317 used to assist the handle component 200 to travel more easily.

As shown in FIG. 9D, the roller bearing 317 of connection arrangement 320 may be used with a binding barrel 321 and screw 323. FIG. 9E illustrates a connection arrangement 325 that may include a plate assembly 327. The plate assembly 327 may be a weldment made of either parts welded together, or parts fastened together. The plate assembly 327 may include a base portion 328 attached to a tube portion 329. The base portion 328 may be inserted within the cavity element 307 and secured by hardware 329 such as screws, nails, bolts, nuts, etc. The base portion 328 is positioned within the cavity element 307 such that the tube portion 329 remains exterior to the side wall surface 120. The handle component 200 is routed through the tube portion 329, which keeps it constrained. When a portion of the handle, or loop, is grasped and pulled, the handle is permitted to freely travel within the tube portion. FIG. 9F illustrates an enlarged view of a connection arrangement 330 comprising channel elements 332, or worm holes, through which the handle component 200 is routed and assembled. The channel elements 332 are formed inward from the side wall surface 120 toward the center of the pad. When a portion of the handle, or loop, is grasped and pulled the selected loop forms a lanyard element while the remaining loops are moved within the aperture element into a taut position around the perimeter edge 125.

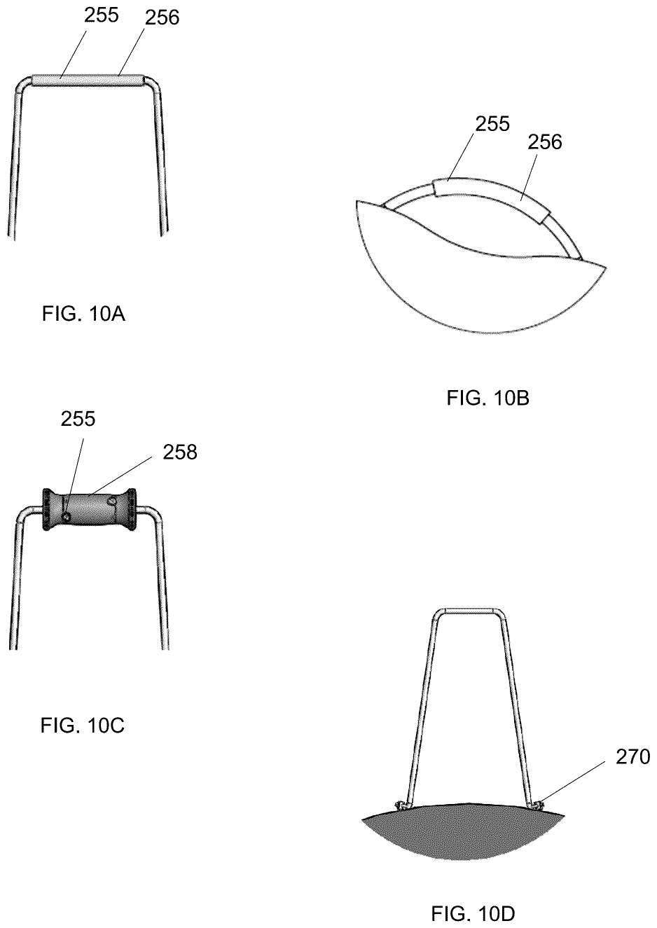

FIG. 10A through FIG. 10C illustrate a hand grip element 255 of the continuous handle component 200 that may be used when the handle component 200 is formed into a lanyard element 250. The lanyard element 250 is used to attach a lifting hook of a machine to move the stabilizer pad, or the lanyard element 250 may be used to manually move or drag the stabilizer pad. It is contemplated that when the pad is lifted by the lanyard element 250, the height at which the load is incurred is raised up from the ground surface to improve ergonomics and decrease risk of lifting related injuries.

A handgrip element 255 may be used to assist with grasping the lanyard element 250 to lift or move the pad. The handgrip element 255 may be a flexible tube 256 that covers a portion of the handle element as shown in FIG. 10A and FIG. 10B. Or the handgrip potion may be a sliding shaft 258 as shown in FIG. 10C. The handgrip element 255 is moveable on the lanyard element 250, i.e., the handgrip element 255 includes a through hole for receiving the lanyard element 250 and provides sufficient clearance so that the handgrip element 255 can slide to various positions along the handle element 200, specifically the lanyard element 250. Therefore, the handgrip element 255 can be used to maneuver the pad while being easily moved to avoid interference with a lifting hook.

It is contemplated that all of the exposed loops 207 may have a handgrip element 255. The handgrip element may provide ergonomic characteristics, e.g., size, shape, texture, pattern, material composition, etc. To further secure the extended portion of the handle component 200 into a lanyard element 250, cable clamps 270 as shown in FIG. 10D may be used to fix the lanyard in place and prevent it from moving. The cable clamps 270 attach at the base of the lanyard element 250 at the side wall surface 120 of the pad.

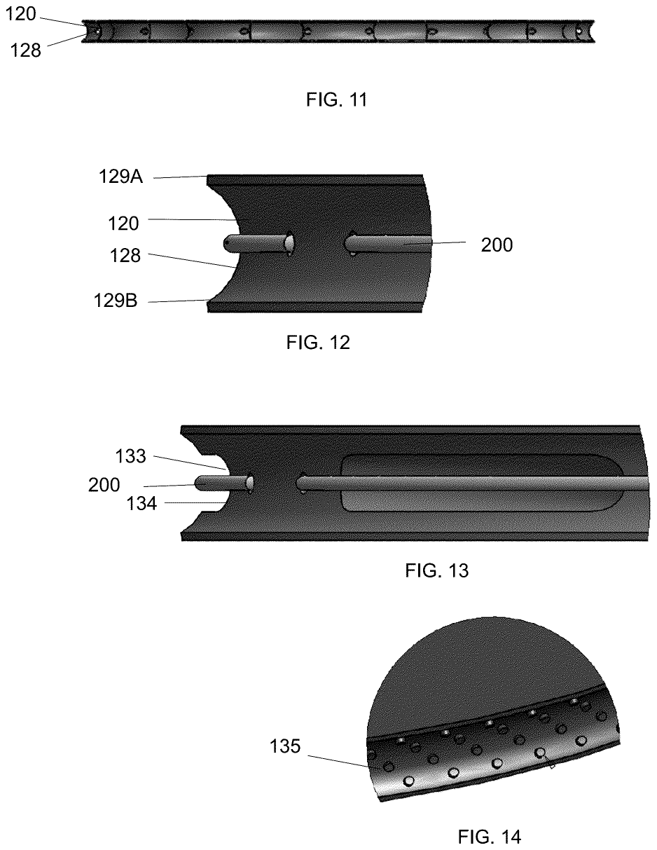

FIG. 11 through FIG. 14 illustrate a stabilizer pad with a side wall surface 120 that is concave toward the center of the pad. The side wall surface 120 may include a concave trench 128, or groove, formed between two ribs 129A, 129B that each extend from the point where the side wall surface 120 meets the first surface 105 and the opposing second surface 110 of the pad. The ribs 129A, 129B form protrusions that prevent the pad from slipping laterally when rolled on along its perimeter edge. Furthermore, each rib 129A, 129B is configured to protrude or embed into a ground surface. This may improve traction between the pad and the ground surface as well as assist with controlling the pad during transport. The concave groove 128 is also sized and shaped to retain the handle component 200 when the handle component 200 is pulled into a taut state. This prevents the handle component 200 from residing outside the perimeter edge 125 and causing interference with anything during transport.

More specifically, FIG. 13 illustrates a stabilizer pad with recessed portions 133 within the concave trench 128 of the side wall surface 120. The recessed portions 133 provide a space, or open area, between the handle 200 and a rear wall 134 of the recessed portion 133. The space provides room for a user to position his or her hand around the handle element 200, particularly when in the taut state, so that the handle component 200 can be pulled out of the taut state into a resting state or pulled into another taut state.

FIG. 14 illustrates a stabilizer pad with texture elements 135. The texture elements may be located on the side wall surface 120 including concave trench 128. The texture elements 135 may be any size, shape, configuration and may be protrusions extending from the surface. The texture elements 135 may be added, embedded, or integrated with the side surface 120, and used to ergonomically assist a user and increase control while transporting, such as by rolling along the perimeter edge, the pad along the ground surface.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A stabilizer pad comprising:
a pad component including a first surface;
an opposing second surface;
a side wall surface between the first surface and the opposing second surface and forming a perimeter edge;
a handle component, wherein the handle component is continuous, flexible element positioned around the perimeter edge, and the handle component is moveable at a point of contact to tighten or cinch around the pad component and form a lanyard element for moving or lifting the stabilizer pad.

2. The stabilizer pad according to claim 1 wherein the handle component is a rope or a cable.

3. The stabilizer pad according to claim 1 wherein the handle component forms a plurality of loops about the perimeter surface.

4. The stabilizer pad according to claim 1 further comprising a concave side wall surface extending around all or a portion of the perimeter edge.

5. The stabilizer pad according to claim 1 further comprising a plurality of cavity elements formed inward from the side wall surface toward a center of the pad.

6. The stabilizer pad according to claim 5, wherein each cavity element comprises a plate assembly.

7. The stabilizer pad according to claim 5, wherein each cavity element comprises a pin element.

8. The stabilizer pad according to claim 7, wherein the pin element rotates.

9. The stabilizer pad according to claim 1, further comprising a plurality of aperture elements formed inward from the side wall surface toward the center of the pad.

10. The stabilizer pad component according to claim 1 wherein the handle component comprises a handgrip element.

11. The stabilizer pad component according to claim 1 wherein the side wall surface of the perimeter edge forms a concave channel.

12. The stabilizer pad component according to claim 1, wherein the sidewall surface includes texture elements.

13. The stabilizer pad component according to claim 11, wherein the concave channel includes texture elements.
